(19) United States
(12) Patent Application Publication
(10) Pub. No.: US 2005/0092110 A1
(43) Pub. Date: May 5, 2005

(54) Sample dispensing device

(76) Inventors: Alexis Bazzanella, Hamburg (DE); Dennis Pump, Hamburg (DE); Irmgard Werner, Hamburg (DE); Markus Kehlenbeck, Hamburg (DE)

Correspondence Address: GRIFFIN & SZIPL, PC, SUITE PH-1, 2300 NINTH STREET, SOUTH, ARLINGTON, VA, 22204, US

(21) Appl. No.: 10/494,261

(22) PCT Filed: Oct. 31, 2002
(86) PCT No.: PCT/EP02/12211

(30) Foreign Application Priority Data
Nov. 2, 2001 (DE) 201 17 914.8

(51) Int. Cl. G01N 1/14

(52) U.S. Cl. 73/863.84

(57) ABSTRACT

A sample delivery device for delivering a particle-containing liquid comprises a sample chamber (12) provided in a syringe pump (10). The sample chamber (12) contains the liquid to be delivered. By moving a piston (14) in the direction indicated by an arrow (16) the sample liquid is, for example, fed through a tube (26) and a delivery opening (30) to wells of a titer plate. According to the invention, the sample chamber (12) is connected with a moving means (32), such as an electromotor, for preventing sedimentation of the particles contained in the liquid, and/or for preventing segregation of the sample liquid.

The invention relates to a sample delivery device for delivering a particle-containing liquid.

Such a delivery device is, for example, a dispensing and/or pipetting means for delivering chemical and/or biological samples. For example, in high throughput screening a large number of wells in microtiter plates are filled with the aid of such sample delivery devices. In modern high throughput screening plants microtiter plates having, for example, 384, 1536, 2080 or more wells are used. Only very small sample volumes are fed to the individual wells. In particular, the volumes lie in the lower microliter and the supermicroliter range.

Suitable dispensing or pipetting means comprise, for example, a micropump having a piezoelectric element, with the aid of which pump correspondingly small droplets for filling the wells can be produced. Further, known dispensing or pipetting means may comprise a syringe pump whose opening is, for example, connected via a tube with a high-speed valve. For example, the piston of the syringe pump generates a pressure in the chamber of the syringe pump as well as in the adjoining tube, and by briefly opening the high-speed valve a correspondingly small volume of liquid is delivered.

In particular because of the small volumes of the delivered sample liquid the dwell time of the sample liquid in the sample chamber, i.e. for example in the chamber of the syringe pump, is relatively long. Depending on the composition of the sample liquid, this may lead to segregation of the sample liquid. In particular during dispensing or pipetting of particle-containing liquids sedimentation of the particles may occur after a short period of time depending on the viscosity and size of the particles. Tests have shown that frequently after as short a period as two minutes sedimentation of the particles occurs. This destroys the homogeneity of the suspension. As a result, different numbers of particles are fed to the individual wells of the titer plate. A reproducible distribution of the particle-containing liquid is thus no longer possible. An identical number of particles or an acceptable small deviation in the number of particles per well is thus not ensured. It is therefore not possible to dispense particle-containing liquids, for example in high throughput screening plants, over a longer period of time of possibly several hours. It must be particularly taken into account that due to the small volumes in the individual wells even small deviations in the homogeneity of the liquid may lead to a considerable falsification of the test results.

The term particle relates in particular also to cells. These are either individual cells or cells which combine to form a particle.

Due to the sedimentation of particles the fluid systems, for example tubes with small diameters, may become clogged. Such clogging can be caused by particles which deposited, for example, on the inner wall of the sample chamber and then came off.

Provision of agitating elements inside the sample chamber involves a very heavy technical expenditure due to the relatively small sample chambers used in particular in high throughput screening processes. Further, the use of agitating elements is of disadvantage in that the particles, in particular cells, may become damaged. When syringe pumps are employed, with the piston of the syringe pump being arranged directly inside the sample chamber, provision of agitating elements inside the sample chamber is further disadvantageous in that a dead volume is created which cannot be emptied by the piston. Since high throughput screening frequently involves the processing of very expensive sample liquids, provision of an agitating element in the sample chamber is not economical. Further, provision of additional elements in the sample chamber has the drawback that the sterilization process becomes more complex and thus more expensive. This is in particular true with agitating elements which are in most cases difficult to clean.

Since the sedimentation behaviour of the particles further depends on the viscosity of the liquid, an adequate homogeneity of the liquid may be attained by preventing viscosity for short periods of time. The use of viscosity-changing additives is however of disadvantage, in particular with regard to cells, in that the cells may become damaged or affected. Further, although the use of viscosity-changing additives may reduce the sedimentation tendency of the particles, it does not eliminate said tendency. In particular in high throughput screening plants in which sample liquids are fed from the sample chamber to the individual wells of the titer plates over a period of several hours, the employment of viscosity-changing additives is not possible due to the long time periods involved.

It is an object of the invention to provide a sample delivery device for delivering particle-containing liquids, with the aid of which the homogeneity of the liquid can be created and/or maintained.

According to the invention, this object is achieved with the features of claim 1.

The sample delivery device according to the invention, which is, for example, a dispensing or pipetting means, comprises a sample chamber for containing the liquid to be delivered and a feed means for feeding the liquid towards a delivery opening. For maintaining the homogeneity of very small liquid quantities in the sample chamber, which are to be delivered, for example, to wells of a titer plate, the sample delivery device comprises, according to the invention, a moving device for moving the sample chamber. By moving the sample chamber and thus the liquid in the sample chamber, for example by shaking, turning or reciprocating the sample chamber, the homogeneity of the sample liquid is maintained and/or created. The sample delivery device according to the invention is thus in particular suitable for delivering, i.e. dispensing or pipetting, a particle-containing, in particular cell-containing, liquid.

By moving the sample chamber the homogeneity of a suspension in the sample chamber is permanently maintained. It is thus in particular possible to keep a sample liquid homogeneous over a longer period of time of, for example, several hours and process said liquid, for example by high throughput screening. In particular in the case of very small sample quantities of only a few microliters or even a few nanoliters the particle number in the individual wells can be kept constant with, for example, small deviations, upon filling the individual wells in particular in the high throughput screening process. Since the moving means according to the invention does not affect the sample liquid as would be the case if agitating means or the like were used, in particular the vitality of the cells is not affected due to the fact that the homogeneity is maintained with the aid of the moving means according to the invention. Further, the device according to the invention prevents sedimentation. Consequently, the fluid system cannot become clogged or contaminated by deposits. Further, an unintentional mixing of sediments with a new liquid is thus prevented.

The sample chamber can, for example, be a liquid reservoir which is preferably connected via a tube or a duct with a feed means, such as a micropump. The micropump comprises a corresponding delivery opening through which the liquid is delivered into a well or any other receiving means. The moving means according to the invention is connected with the reservoir and sets the reservoir together with the liquid in motion.

Preferably, the sample chamber is the chamber of a syringe pump in which the piston of the syringe pump is guided. In this case the moving means is connected with the overall syringe pump such that the overall syringe pump is moved to maintain and/or create the homogeneity of the liquid in the sample chamber, i.e. the chamber of the syringe pump. Provision of such a piston pump as feed means offers the advantage that the sample reservoir is arranged directly inside the pump. Since according the invention no means such as agitators or the like are arranged inside the sample chamber, the liquid can also be moved from outside with the aid of the moving means such that the sample chamber can be completely emptied by the piston of the piston pump. A dead volume is not created inside the sample chamber. This ensures economical use of the expensive sample liquids. Further, mixing of two liquids, which are processed one after the other, is prevented. Moreover, cleaning of such a piston pump without any additional agitating means or the like is considerably easier such that, for example, good sterilization conditions can be guaranteed.

The feed means of the sample delivery device, which is in particular a syringe pump, is, for example, connected via a fluid segment, such as a tube, with a delivery means comprising a delivery opening. The delivery opening may, for example, be a tube end. Preferably, the delivery opening is provided in a tip or the like which is connected with the tube and may be exchangeable.

The feed means, in particular the syringe pump, is preferably connected via a holder with the moving means. The moving means may, for example, be an electromotor, in particular a step motor, with the aid of which turning of the sample chamber is realized. In particular, turning is effected about the transverse axis of the piston pump, in particular the syringe pump. In this connection, a syringe pump comprises an essentially cylindrical cavity serving as sample chamber. In this cavity a piston is guided, wherein movement of the piston in longitudinal direction of the cylindrical cavity causes liquid to be delivered via a pump outlet which is normally arranged opposite the piston.

To improve the homogeneities of the liquids, turning is not effected continuously in one direction but the sense of turning is changed, i.e. the sample chamber is reciprocated. Preferably, the sense of turning is changed at an angle of turning between 180 and 360 degrees. The resulting accelerations of the liquid and the particles, in particular the cells, contained in the liquid ensure thorough mixing and maintaining of the homogeneity.

Hereunder the invention is explained in detail on the basis of a preferred embodiment with reference to the accompanying drawings in which:

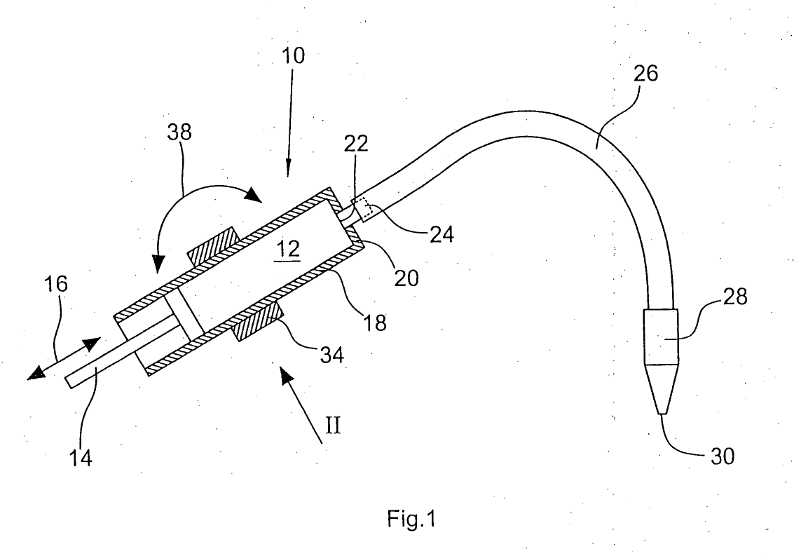

FIG. 1 shows a schematic side view, partly in section, of the device according to the invention,

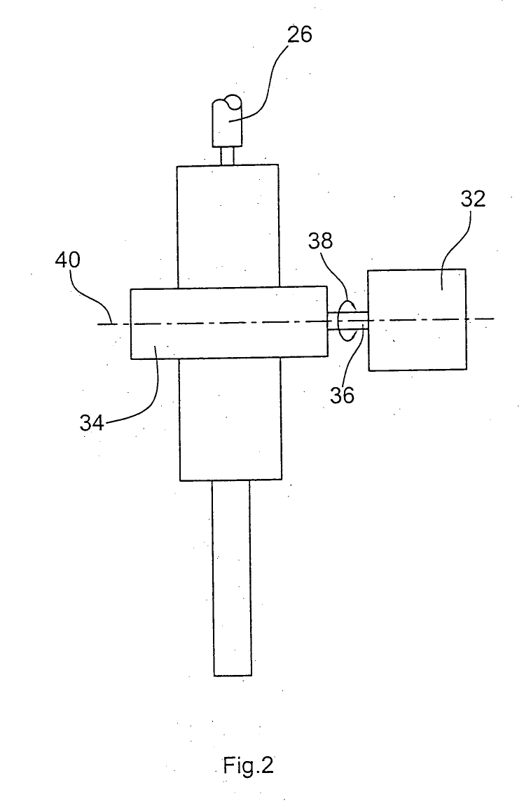

FIG. 2 shows a schematic front view of the device as seen in the direction of arrow II of FIG. 1,

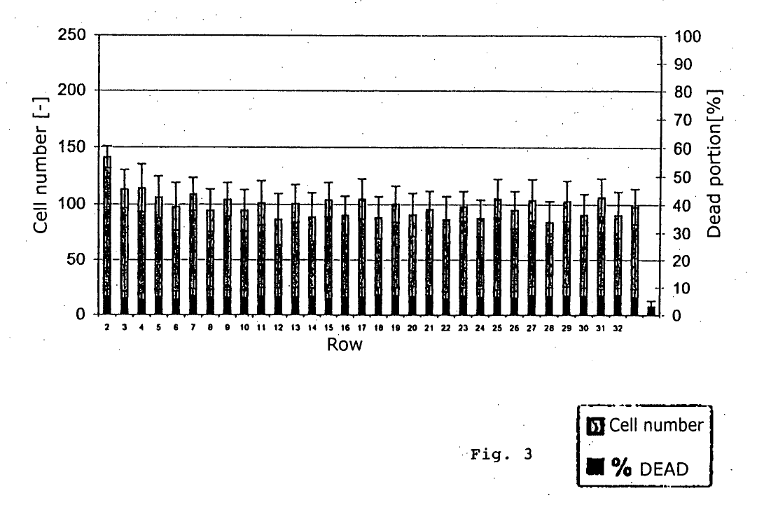

FIG. 3 shows a diagram representing the distribution of cells in a titer plate in the case of dispensing without the moving means according to the invention, and

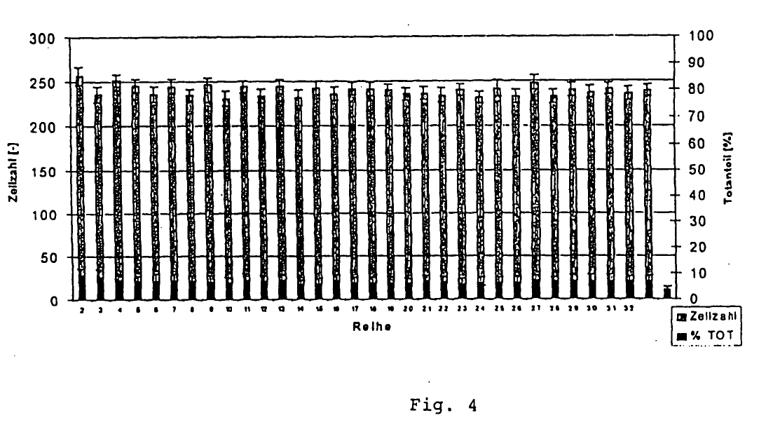

FIG. 4 shows a diagram representing the distribution of cells in a titer plate in the case of dispensing with the moving means according to the invention.

The sample delivery device schematically shown in FIGS. 1 and 2, which is particularly suitable for delivering very small quantities of particle-containing liquids, i.e. for example into individual wells of titer plates, comprises a syringe pump 10 serving as a feed means for feeding a liquid. The liquid containing in particular particles is located in a sample chamber 12 of the syringe pump. The sample chamber 12 is, for example, of cylindrical configuration. In the sample chamber 12, which, in the embodiment shown, is the piston space of the syringe pump 10, a piston 14 is arranged which is capable of being displaced in the piston space 12 in the direction indicated by an arrow 16. When the piston 14 is introduced into the piston space or sample chamber 12 in longitudinal direction of the housing 18 defining the cylindrical sample chamber, sample liquid is delivered from the sample chamber through an opening 22 provided in a bottom 20 of the housing 18. The opening 22 is arranged in the bottom 20 opposite the piston 14 and is generally concentrically with the piston 14. At the opening 22 a hub 24 is provided, to which, in the embodiment shown, a tube 26 is attached. The tube 26 is connected with a delivery tip 28. The delivery tip 28 may be exchangeable and comprises a delivery opening 30 through which the liquid is delivered towards the individual wells of a titer plate.

Additionally, a high-speed valve can be provided in the tube 26 or in the delivery tip 28. The high-speed valve can precisely control the delivery of the sample liquid. Further, provision of a high-speed valve allows the piston 14 to be continuously pushed into the piston space 12, and the drop-by-drop delivery of the sample liquid to be exclusively controlled via the valve.

It is further possible to connect the sample chamber or piston space 12 with a reservoir which contains a larger quantity of sample liquid. This can, for example, be realized via an additional opening in the housing 18 or via a tube 26 branch provided with a valve. By correspondingly switching the valve, the syringe pump can be drawn up by withdrawing the piston 14, thus drawing in sample liquid from the reservoir. This reservoir may be connected, in addition to the syringe pump 10, with a moving means for moving the liquid and thus maintaining the homogeneity of the liquid.

The volume of the pump chamber 12 is, in particular when the sample delivery device according to the invention is employed, a great deal larger than the individual volume of the very small sample liquid quantities delivered into the individual wells. In particular, the volume of the pump chamber 12 is ten times larger, preferably at least a hundred times larger, that the delivered individual volumes.

To maintain the homogeneity of the sample liquid in the pump chamber 12 the syringe pump 10 is, according to the invention, connected with a moving means 32 (FIG. 2), such as an electromotor. Preferably, the electromotor 32 is a step motor. The syringe pump 10 is connected via a holding or clamping device 34 and a shaft 36 with the motor 32. With the aid of the motor 32 the syringe pump 10 can be preferably reciprocated in the direction indicated by an arrow 38. This results in turning of the syringe pump 10 along with the sample chamber 12 about a transverse axis 40 of the syringe pump 10. In particular during the reciprocating movement accelerations occur which cause the particles, in particular the cells, in the sample liquid to be homogeneously distributed or remaining homogeneously distributed. In the case of liquids which do not contain any particles the moving means 32 according to the invention prevents the liquids from segregating.

The inventive movement of the syringe pump and connection of the syringe pump via a tube with a delivery means 28 or the like allow the sample chamber 12 to be permanently kept in motion, irrespective of whether or not liquid is delivered during the movement. Movement of the sample chamber 12 and thus the liquid contained in the sample chamber need thus not be interrupted for the purpose of delivering liquid. Preferably, the syringe pump 10 is already in motion when the sample chamber 12 is being filled with sample liquid. In the case of a pipetting device filling can be carried out through the tube 26 by drawing sample liquid through the opening 30 and the tube 26 into the sample chamber. In the case of a dispensing means the sample chamber 12 is connected with an additional reservoir such that the sample liquid is drawn from the reservoir into the sample chamber 12 and is then delivered through the tube 26 and the opening 30 into the wells or the like. It is further possible to move the syringe pump 10 over a given period of time of, for example one to three minutes, after filling of the sample chamber 12 and prior to delivering the sample liquid through the delivery opening 30 to ensure that the liquid in the sample chamber 12 has a high homogeneity before initial delivery of a small quantity of sample liquid. This guarantees that even at the beginning of sample liquid delivery no variations in the cell number or the like occur.

The diagram shown in FIG. 3 represents a test result with regard to the number of cells and the portion of dead cells, wherein dispensing of the sample liquid was carried out using a sample delivery device without a moving means. The sample liquid was thus not moved in the sample chamber 12 during the delivery process. In the diagram, the cell numbers are plotted as grey bars against a row of a titer plate. The individual wells of the rows of the titer plates were filled one after the other. Filling was effected with the aid of the dispensing system PreSys of the Cartesian company. During the filling process the piston of the syringe pump was continuously moved. Filling of the individual wells was carried out by correspondingly actuating a high-speed valve provided in the tube which connects the syringe pump with the outlet means. For determining the overall cell number per row of the titer plate, the cells were dyed prior to the dispensing process with a vital dye combining with proteins in the cytoplasm. CMFDA (chloromethylfluorescein diacetate) was used as dye. By charging ethidium homodimer into the individual wells the cell core of killed cells was dyed either after the dispensing process. Readout of the titer plate was effected using an image system for fluorescent samples. In this connection, the two dyes were excited by light with a wavelength of 480 nm. The emission wavelength for CMFDA is 510 nm and the emission wavelength for ethidium homodimer is 680 nm.

As can be seen from the Figure, the cell number considerably varies between the individual rows of the titer plate. The variation limits range between approximately eighty and one hundred and forty cells per row. Such high variations in the cell numbers lead to a strong falsification of the test results. The dead portion also varies strongly across the individual rows of the titer plate.

Compared to this, the same test as explained with reference to FIG. 3 was carried out, as shown in FIG. 4, wherein however the syringe pump 10 was moved by the moving means according to the invention during the overall dispensing process. As can be seen from FIG. 4, the cell number is subject to a considerably smaller variation. The percentage of the dead portion, too, is subject to a substantially smaller variation and thus negligible. Further, it turned out that the initial concentration of the dispensed sample liquid and the measured number of cells were the same.

Further, in both FIGS. 3 and 4 the standard deviations are plotted. These deviations, too, are considerably smaller when the syringe pump is moved (FIG. 4).

1. Cell suspension delivery device for delivering a cell-containing liquid, in particular in very small quantities, comprising
a sample chamber for containing the liquid to be delivered, and
a feed means connected with the sample chamber for feeding the liquid towards the delivery opening, and
a moving means connected with the sample chamber for moving the liquid in the sample chamber wherein the moving means causes the sample chamber to be turned about the transverse axis of the feed means.

2. Cell suspension delivery device according to claim 1, characterized in that a piston pump, in particular a syringe pump, is provided as feed means.

3. Cell suspension delivery device according to claim 2, characterized in that a piston space in which a piston of the piston pump is arranged serves as sample chamber.

4. Cell suspension delivery device according to claim 1, characterized by a change of the sense of turning.

5. Cell suspension delivery device according to claim 1, characterized in that the volume of the sample chamber is a great deal larder than the individual volume of the delivered very small quantities.

6. Cell suspension delivery method for delivering a cell-containing liquid in particular in very small quantities the method comprising the following steps:
maintaining the homogeneity of the cell suspension contained in the sample chamber by turning the sample chamber about a transverse axis of a feed means connected with the sample chamber, and
feeding the liquid with the aid of the feed means towards a delivery opening.

7. Cell suspension delivery device according to one of claim 6, wherein maintaining of the homogeneity is effected exclusively by turning about the transverse axis.

8. Cell suspension delivery method according to claim 6, wherein the sense of turning of the sample chamber is changed.

9. Cell suspension delivery method according to claim 6, wherein the sample chamber is reciprocated.

10. Use of a sample delivery device comprising a sample chamber for containing a liquid to be delivered, a feed means connected with the sample chamber for feeding the liquid towards the delivery opening, and a moving means connected with the sample chamber for moving the liquid in the sample chamber,
in particular a cell suspension delivery device according to claim 1,
for delivering a cell-containing liquid, in particular by applying the method according to claim 6.
